(19) United States
(12) Patent Application Publication
(10) Pub. No.: US 2023/0006785 A1
(43) Pub. Date: Jan. 5, 2023

(54) SYSTEM AND METHOD FOR TRANSMITTING DATA OVER A DIGITAL INTERFACE

(71) Applicant: Creative Technology Ltd, Singapore (SG)

(72) Inventors: Teck Chee LEE, Singapore (SG); Toh Onn Desmond HII, Singapore (SG); Jenny Afliccion ESTEBAN, Singapore (SG)

(73) Assignee: Creative Technology Ltd, Singapore (SG)

(21) Appl. No.: 17/779,118

(22) PCT Filed: Nov. 20, 2020
(86) PCT No.: PCT/SG2020/050678

§ 371 Date: May 23, 2022

Related U.S. Application Data
(60) Provisional application No. 62/939,622, filed on Nov. 23, 2019.

(51) Int. Cl. H04L 5/00; G06F 3/16; H04L 1/16

(52) U.S. Cl. CPC H04L 5/0044; G06F 3/162; H04L 1/16

(57) ABSTRACT

Systems and techniques are provided to transmit data over a digital interface between a sender and a receiver. The digital interface is configured for transmitting a primary type of data as opposed to a secondary type of data. Nevertheless, systems and techniques are provided where the secondary type of data can be transmitted in the digital interface. As such, the primary and/or secondary types of data are transmitted from the sender to the receiver via the digital interface. The primary and secondary types of data may be different and/or unrelated and could be any type of data including, but not limited to, audio data, general data, and bulk data. Yet, the received primary and secondary types of data are still useful after the transmission.

### CROSS REFERENCES TO RELATED APPLICATIONS

This application is a National Stage (§ 371) of International Application No. PCT/SG2020/050678, filed 20 Nov. 2020 and entitled “SYSTEM AND METHOD FOR TRANSMITTING DATA OVER A DIGITAL INTERFACE”, which claims the benefit of U.S. Provisional Application No. 62/939,622, filed 23 Nov. 2019 and entitled “SYSTEM AND METHOD FOR TRANSMITTING DATA OVER A DIGITAL INTERFACE”, the disclosure of which is herein incorporated by reference in its entirety.

### BACKGROUND OF THE INVENTION

### 1. Field of the Invention

The present invention relates to transmitting data between devices. More particularly, the present invention relates to a system and method for transmitting data over a digital interface between devices.

### 2. Description of the Related Art

Digital interfaces are used to transmit data between electronic devices. Certain digital interfaces are designed or configured specially to transmit a particular type of data on a particular data path. For example, digital interfaces such as USB Audio are configured to transmit audio data on an audio data path (e.g., audio channel). However, having digital interfaces designed or configured for transmissions of only certain types of data (e.g., audio data) on certain data paths can be limiting in cases where there are no other or limited concurrent suitable alternatives for transmissions of other types of data (e.g., general data, bulk data); thus, causing a constrained efficiency in the digital interface's usage. As a consequence, systems with these dedicated digital interfaces can also be limiting.

Therefore, there is a need to utilize dedicated digital interfaces for different data types. Specifically, there is a need to use digital interfaces that are dedicated for certain types of data for transmission of other types of data. There is also a need to accommodate for the transmission of different types of data over a dedicated digital interface.

Accordingly, it is desirable to provide systems and methods for transmitting data over a digital interface to address the above needs.

### SUMMARY OF THE INVENTION

In one aspect of the invention, a method for transmitting data over a digital interface is provided. The method includes 1) receiving at a receiver data transmitted from a sender via the digital interface; and 2) processing at the receiver the transmitted data. The transmitted data is data that includes a primary type of data and a secondary type of data. The digital interface is configured for transmitting the primary type of data as opposed to the secondary type of data in one or more channels of the digital interface. The secondary type of data is handled such that either the secondary type of data alone or in combination with the primary type of data is transmitted in the one or more channels of the digital interface.

According to various embodiments, the one or more channels are each an audio channel. The primary and secondary types of data are either related or unrelated. The data may either be audio data, general data, or bulk data.

In another aspect of the invention, a system for transmitting data over a digital interface is provided. The system includes 1) a sender configured to transmit data; 2) a receiver configured to receive data transmitted from the sender via the digital interface; and 3) the digital interface. The transmitted data is data that includes a primary type of data and a secondary type of data. The digital interface is configured for transmitting the primary type of data as opposed to the secondary type of data in one or more channels of the digital interface. The secondary type of data is handled such that either the secondary type of data alone or in combination with the primary type of data is transmitted in the one or more channels of the digital interface.

In another aspect of the invention, a receiver is provided. The receiver includes a processor configured to receive data transmitted from a sender via a digital interface and process the transmitted data. The transmitted data is data that includes a primary type of data and a secondary type of data. The digital interface is configured for transmitting the primary type of data as opposed to the secondary type of data in one or more channels of the digital interface. The secondary type of data is handled such that either the secondary type of data alone or in combination with the primary type of data is transmitted in the one or more channels of the digital interface.

In yet another aspect of the invention, a sender is provided. The sender includes a processor configured to process and transmit data to a receiver via a digital interface. The transmitted data is data that includes a primary type of data and a secondary type of data. The digital interface is configured for transmitting the primary type of data as opposed to the secondary type of data in one or more channels of the digital interface. The secondary type of data is handled such that either the secondary type of data alone or in combination with the primary type of data is transmitted in the one or more channels of the digital interface.

The invention extends to a machine readable medium embodying a sequence of instructions that, when executed by a machine, cause the machine to carry out any of the methods described herein.

Some of the advantages of the present invention include having: 1) digital interfaces dedicated for transmission of certain data types adapted for transmission of different data types (e.g., audio and data instead of just audio); 2) efficient encoding and decoding techniques for embedding data; 3) minimal modification to existing system component architecture; 4) real-time adaptation; 5) adjustable audio fidelity quality; 6) maximized data rate; 7) a feedback path to ensure transmission integrity. These and other features and advantages of the present invention are described below with reference to the drawings.

### BRIEF DESCRIPTION OF THE DRAWINGS

FIG. 1 is a system block diagram for transmitting data over a digital interface according to various embodiments of the present invention.

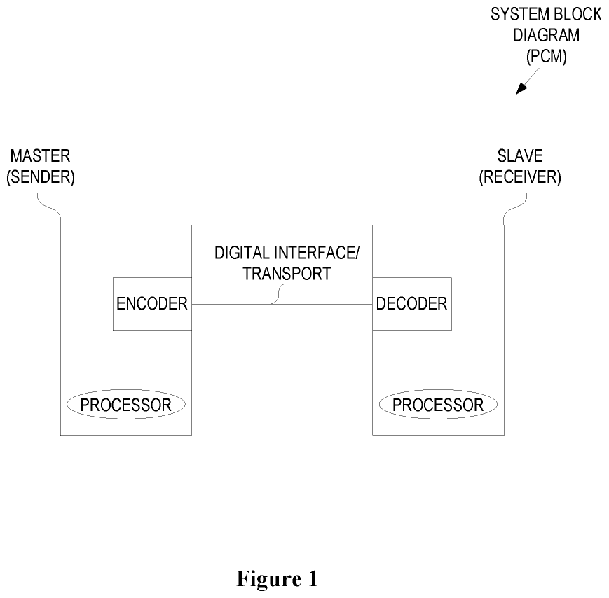

FIG. 2 is a flow diagram for transmitting data over a digital interface according to various embodiments of the present invention

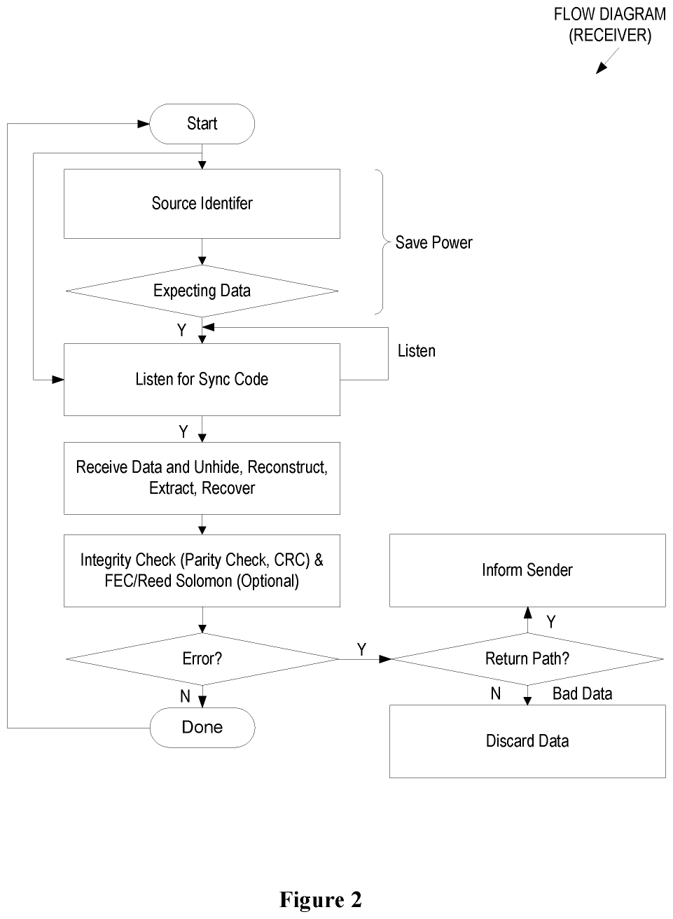

FIG. 3 is a flow diagram for transmitting data over a digital interface according to various embodiments of the present invention

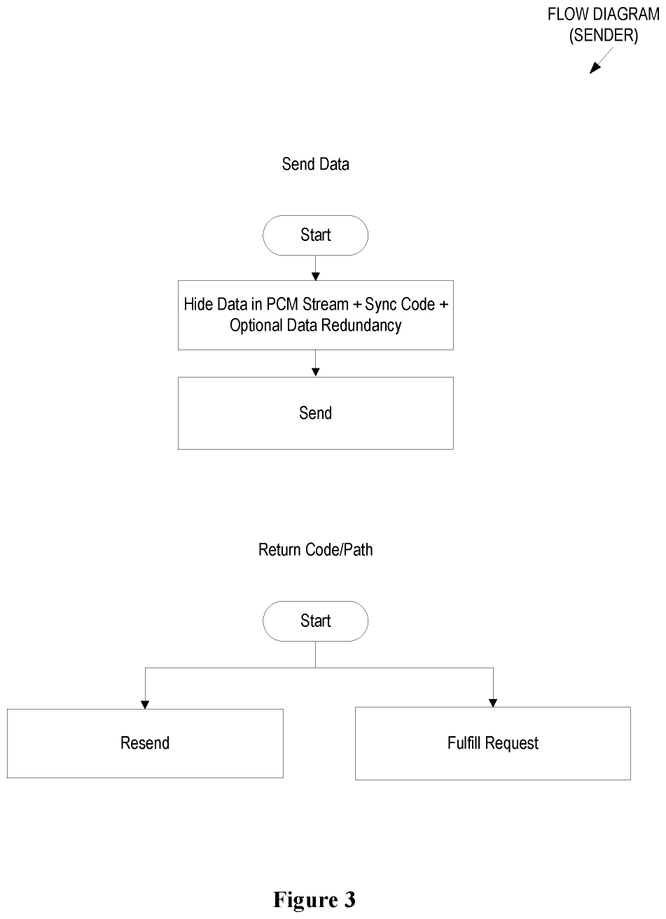

FIG. 4 is a diagram for transmitting data over a digital interface according to various embodiments of the present invention

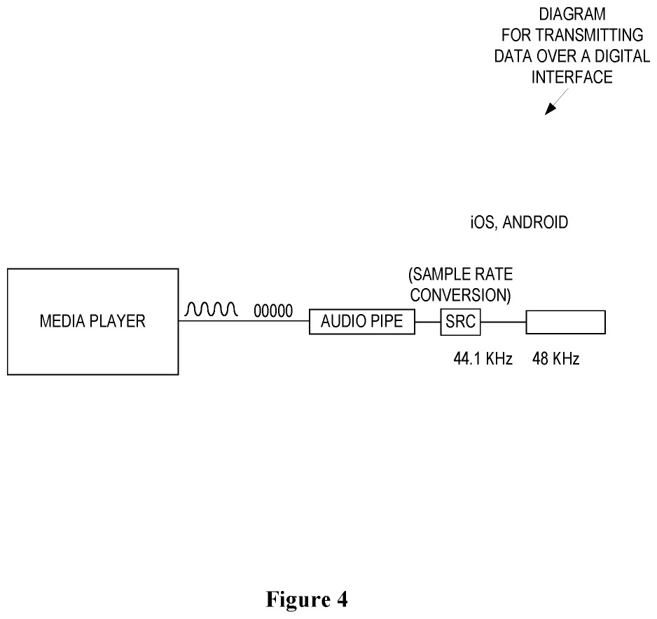

### DETAILED DESCRIPTION OF PREFERRED EMBODIMENTS

Reference will now be made in detail to preferred embodiments of the invention. Examples of the preferred embodiments are illustrated in the accompanying drawings. While the invention will be described in conjunction with these preferred embodiments, it will be understood that it is not intended to limit the invention to such preferred embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known mechanisms have not been described in detail in order not to unnecessarily obscure the present invention.

It should be noted herein that throughout the various drawings like numerals refer to like parts. The various drawings illustrated and described herein are used to illustrate various features of the invention. To the extent that a particular feature is illustrated in one drawing and not another, except where otherwise indicated or where the structure inherently prohibits incorporation of the feature, it is to be understood that those features may be adapted to be included in the embodiments represented in the other figures, as if they were fully illustrated in those figures. Unless otherwise indicated, the drawings are not necessarily to scale. Any dimensions provided on the drawings are not intended to be limiting as to the scope of the invention but merely illustrative.

Systems and techniques are provided to transmit data over a digital interface between sender and receiver devices (e.g., computer, mobile phone, media players, mobile devices, etc.). The digital interface is configured for transmitting a primary type of data as opposed to a secondary type of data; thereby, resulting in at least a technical problem of constrained efficiency in digital interfaces and systems using them. Nevertheless, systems and techniques are provided where the secondary type of data can be transmitted in the digital interface to solve the technical problem of constrained efficiency in digital interfaces and systems using them. As such, the primary and/or secondary types of data are transmitted from the sender to the receiver via the digital interface. The primary and secondary types of data may be different and/or unrelated and could be any type of data including, but not limited to, audio data, general data, and bulk data. Yet, the received primary and secondary types of data are still useful after the transmission.

An advantage of the present invention allows for the use of an existing digital interface (or digital transport or channel) that was designed or configured for transmitting a particular data type (e.g., primary type data) to be used for transmitting additional related/unrelated information, which may be in the form of another data type (e.g., secondary type data). For example, digital audio transmission has become ubiquitous in consumer AV devices via digital interfaces (e.g., optical/coaxial SPDIF, HDMI, USB Audio, AES i2s, etc.). Although these transports are digital in nature, they are configured/designed specifically for transmitting audio data (e.g., on audio channel(s) specific for audio data) instead of transmitting data such as bulk data or general data (other than data for handshaking since the purpose of handshaking is to establish a transport). Therefore, rather than establishing or creating separate data channel(s), the present invention can allow for the transmission of data such as bulk data or general data on digital audio-playback transports using the existing audio channel(s).

To make a person skilled in the art understand the technical solutions to the technical problem better, the following clearly and completely describes the technical solutions in the example embodiments with reference to any accompany drawings. The described embodiments are merely some but not all of the embodiments. All other embodiments obtained by a person of ordinary skill in the art based on the embodiments without creative efforts shall fall within the protection scope.

Although the preferred embodiments of the present invention will be described with respect to audio and audio transports, the present invention can be adapted for other media types and transports. Data generally sounds like white noise and is very loud. Its' presence in the transport should not result in an unpleasant user-experience or worse, a damaged loudspeaker/transducer. Therefore, once the audio transport is established, the preferred embodiments of present invention are based on various requirements, including: 1) making as little modification as possible to the existing architecture (e.g., preserve existing architecture as much as possible; do minimal modification if any in order for the data to ride on the existing transport); 2) having adjustable audio fidelity quality and options to preserve its' quality as much as possible (e.g., none or minimal distortion when data is transmitted); 3) having data rate set as high as possible; 4) having a data return control path, though optional, is desirable to confirm that the data was received successfully by the receiver from the sender (although a bidirectional path is desirable, it can merely be an asymmetric path and it does not need to be a high capacity return path if it's simply for feedback and acknowledgment (e.g., yes, no, success, failed). Some of these requirements are competing and a balance may be made depending on use-case.

According to one embodiment, data is hidden in a PCM (pulse code modulation) audio stream, which includes samples of an audio waveform. For example, a last n-bits technique may be implemented for data hiding. To elaborate, the last bit of a 16 bit data that represents a single sample may be used for data. The last bit of the audio signal may be ignored and data injected into it at the sender. Then the last bit with the injected data may be retrieved to construct the data at the receiver. One bit or n bits may be used for the injected data. Adjusting n controls bandwidth vs. audio fidelity tradeoffs. The more n increases for data bandwidth, the more audio fidelity suffers. Depending on the length of the sample, one or two bits may be acceptable. Yet, 5 or 6 bits may not be acceptable (strange things may be heard). Therefore, balancing between increasing bandwidth and maintaining acceptable audio fidelity is necessary. Since the least significant bit normally represents the smallest change, changes to the least significant bit will affect the audio signal the least.

For another example, data hiding in the frequency domain includes at the sender a first transform into the frequency domain, hide or embed data in the higher frequency where the higher frequency content is replaced with injected data, then inverse transform to get back to time domain for transmission to the receiver. Then at the receiver, a complemented process is performed for decoding, extracting, un-hiding, reconstructing, and/or recovering the data. High frequency is chosen because human ears are less sensitive to hearing changes in the high frequencies as compared to low frequencies. Hiding can be done in different domains (e.g., wavelet, DCT (discrete cosine transform), and Hadamard transform). Since data is being hidden in the PCM, the data hiding can include FEC (forward error correction). FEC contains some redundancy data for correcting errors in the received data without using a back channel. FEC may be as simple as sending some redundancy data twice or as sophisticated as Reed Solomon coding. Yet, general error correction may be included with the use of a return path (e.g. retransmit)

None of these schemes under this embodiment requires any change in the existing transport. Rather, they capitalize on modifying the PCM data. Therefore, these schemes can work with any transport transmitting PCM data. Choosing the frequency band determines bandwidth vs. audio fidelity tradeoff. There can also be dynamic bandwidth adjustments depending on music content. For example, the frequencies may dynamically increase or decrease the chosen band of frequencies (may include any of low, mid, or high (preferable) frequencies) based on achieving acceptable audio fidelity for the music content being transmitted for playback. Aspects of this embodiment may capitalize on a masking effect to inject more data into surrounding frequency bands of a high energy band. Further, the receiver may be signaled by the sender to mute the volume on playback during a pause or transition between music tracks where the sender transmits data at full bandwidth between music tracks. During an audio stream for playback, the present invention allows for audio on a separate channel, data on a separate channel, and audio and data (in same packet/file and/or in different packets/file) on a common channel to be transmitted.

Another aspect of this embodiment may include having the sender (source) compress the PCM data (using existing compression methods such as ADPCM, MP3, or AAC), and use the recovered bandwidth to transmit data. Receiver (sink) then un-compresses the PCM data and reconstructs/recovers the transmitted data. A ten times compression is common, leaving about 90% of the bandwidth available for data transmission. Using half of this to attenuate the volume level, there is still about 45% data efficiency. The compression may be performed on a continuous stream (rather than per-file), e.g., it is possible to achieve higher compression level during silent pauses or transitions between the music tracks. Although this may increase the complexity of the system, it further increases the data bandwidth.

Other aspects of this embodiment may include implementing Sync signals to trigger the receiver to start decoding incoming data. Sync signal can be in a predefined header (a sequence of bits) which may contain an identifier and optional parameters describing the incoming data. The identifier is preferred since it is unlikely to occur in natural music/sound.

According to another embodiment, some modifications may be made at the receiver and/or sender. For example, a technique may be implemented to use free audio channels. If the transport allows for multichannel, e.g. 8 channels, but only 2 channels are being used to transmit stereo, then it is possible to exploit the remaining unused and free 6 channels to transmit data. For USB audio, it is configurable to have 8 channels. In other words, it has the bandwidth to handle 8 channels (e.g., speaker channels FR, FL, RR, RL, C, SL, SR, and SUB). Receiver may declare to sender that it can handle 8 channels. Sender may respond that it only uses two channels. Receiver may still request for sender to provide 8 channels. As such, sender sends 2 channels and leaves the other 6 channels empty for sender/receiver to transmit embedded data. To negotiate 8 channels, there might not be an available handshake standard, so it may be necessary to fake the 8 channels. The amount of modifications to the receiver and/or sender may depend on the amount of control that is available over the receiver and/or sender.

For another example, a technique for channel reduction may be implemented. To elaborate, the technique includes reducing stereo to mono and transmitting data using the freed up channel. A downside is that the data channel is likely to sound noisy. Alternatively, it is possible to omit the whole stereo audio, then sender will have two freed up channels to transmit data at full bandwidth. This will affect the end user from receiving any audio, but it may be fine if this is short or temporary for embedded data transmissions. User may just hear a short pulse and then be done with it.

According to various embodiments, a return channel (or reverse channel) may be implemented. There are various ways to do this. For example, a technique includes utilizing a protocol's recording path. USB Audio may be bi-directional to allow playback and recording. The recording path is digital and may be used in a similar manner to provide a return channel to the playback source. By opening the recording path, it is possible to use it to communicate from receiver back to sender.

For another example, a technique includes utilizing a protocol's control path. Some protocols such as USB HID (human interface device) protocol has a control path. Most audio playback devices have some controls (e.g., play, pause, forward, reverse) buttons, and their key presses are transmitted back to the playback source via USB HID. The receiver may emulate these key presses to transmit data back to the playback source. For a mobile phone, a USB Audio transport is established between the mobile phone and a device to playback audio on the device. Since the source is remote at the mobile phone (sender), it is possible that the mobile phone can accept some control of the media playback (e.g., play, pause, next track, forward, reverse etc.) from the device (receiver). During the data transmission, these controls can be used as a way to provide feedback to the sender. Forward control could mean “thank you, data received properly.” Reverse control could mean “there is a problem with data transmission.” By having just these two states, various representations of the data are possible. For instance, transmitting back two signals can be implemented similar to Morse code. In particular, Morse code has one state (up, down) and duration that can be used to transmit any data. If two states, more data can be transmitted faster. So by using forward, reverse, and other existing commands, it is possible to have any number of corresponding states (e.g., 2, 3, 4, etc.). In this way, control commands can be used to transmit data from receiver back to sender.

For yet another example, a technique includes utilizing an auxiliary path. Auxiliary paths are return paths that are not part of the transmission path protocol. In the case of a Bluetooth headset, the microphone path may be used in conjunction with USB Audio transmission.

Finally in another example, a technique includes utilizing manual feedback. At the data receiving end, the device's LED blinking and color may provide a ‘manual’ user return path. So a successful transmission should conclude with a joyous display of blinks and colors, and conversely for failed transmission. The user can then tap some sender's user-interface button to retry.

It is noted that individual embodiments may be described as a process which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a drawing. A process may correspond to a method, a function, a procedure, a subroutine, a subprogram, etc.

It is also noted that one or more features/process described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more non-transitory tangible computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein.

Various embodiments of the present invention include utilizing an existing digital interface configured or dedicated for transmission of a primary data type (e.g., audio data) and then reconfiguring, rededicating, or adapting it or its' related system components for transmission of a secondary data type (e.g., bulk data, general data, etc.). The secondary data type may be embedded, encoded, hidden, and/or masked in the transmission with or without the primary data type. Various techniques (e.g., last N-bit(s), dynamic bandwidth adjustment compression, muting audio, free channels, return path, etc.) are used to improve efficiency, data rate, audio fidelity, data bandwidth, and/or transmission integrity. Techniques may also be implemented in real-time.

In general, the present invention includes transmitting data over digital audio-playback transports. Features includes: 1) preserve existing transport; 2) very little to no modification; 3) not distorting the audio; 4) providing a return control path (via recording/mic path, or control commands (Play/Pause/etc.). Data hidden (embedded) in PCM audio stream. Various means could be used to embed the data:
1. Replacing last bit(s) of audio with data to be transmitted. (Eg 16 bit, replace 1 bit with data=48 kb/s)
2. Embedding in High Frequency components after the transform from Time to Frequency Domains. (16 bit=48 Khz)=>24 Khz bandwidth. Assume human hearing range 20 KHz, have 4 KHz to use for the data.16 bits=2 bytes. Throughput=4K×2 bytes=8 KB/s.
3. Transmitting during “pause” between music tracks. (Can use more bits.) There can have an optional step of Forward Error Correction/Reed Solomen. The receiver can be configured to detect when this is happening by using techniques such as:
Sync code embedded in the audio data. Receiver listening all the time/when right devices are detected.
Handles possibility of real audio having the sync code (which is not actually a sync code, just coincidence).
Error checking & handling (Parity check, CRC) such as discarding the “data” received.

Advantageously, various embodiments of the present invention may be combined and further provide: 1) the ability to use an existing infrastructure such as an audio transport configured for audio (primary data type) transmission and use it for data (secondary data type) transmission; 2) the ability to maximize bandwidth for data (secondary data type) transmission while maintaining adequate audio fidelity from the audio transmission (primary data type); 3) the ability to improve latency if receiver does not need to differentiate between audio or data (e.g., using free audio channels embodiments as a dedicated or re-dedicated channel for data; not using sync signal/tone); 4) the ability to not be constrained to low throughput (e.g., with regards to data hiding using last N-bits, N can be very large or even replace the entire PCM).

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method for transmitting data over a digital interface, comprising:
receiving at a receiver data transmitted from a sender via the digital interface; and
processing at the receiver the transmitted data,
wherein the transmitted data is data comprising a primary type of data and a secondary type of data,
wherein the digital interface is configured for transmitting the primary type of data as opposed to the secondary type of data in one or more channels of the digital interface, and
wherein the secondary type of data is handled such that either the secondary type of data alone or in combination with the primary type of data is transmitted in the one or more channels of the digital interface.

2-15. (canceled)

16. The method as recited in claim 1, wherein the secondary type of data is embedded in the one or more channels of the digital interface such that both the primary type of data and the secondary type of data are transmitted together in the same one or more channels of the digital interface and wherein the digital interface is an audio digital interface.

17. The method as recited in claim 16, wherein the processing at the receiver further includes searching for and extracting the secondary type of data from the transmitted data.

18. The method as recited in claim 16, wherein the secondary type of data is hidden in a portion of a bandwidth generated by sample rate conversion.

19. The method as recited in claim 16, wherein the primary type of data comprises audio data and the secondary type of data comprises non audio type of data.

20. The method as recited in claim 16, wherein the primary type of data and the secondary type of data are transmitted in a PCM stream or an audio file.

21. The method as recited in claim 16, wherein the sample rate conversion is applied to a PCM stream of audio.

22. The method as recited in claim 16, wherein the primary and secondary types of data are concurrently transmitted in a packet.

23. The method as recited in claim 16, wherein the primary and secondary types of data are unrelated and wherein the secondary type of data is hidden in the frequency domain.

24. The method as recited in claim 16, wherein the primary and secondary types of data are unrelated and further comprising performing at the receiver data integrity checks of the transmitted data.

25. The method as recited in claim 16, wherein the data is selected from the group consisting of audio data, general data, and bulk data.

26. The method as recited in claim 16, further comprising determining via a data return control path that the secondary data has been received.

27. A system for transmitting data over a digital interface, comprising:
a sender configured to transmit data;
a receiver configured to receive data transmitted from the sender via the digital interface; and
the digital interface,
wherein the transmitted data is data comprising a primary type of data and a secondary type of data,
wherein the digital interface is configured for transmitting the primary type of data as opposed to the secondary type of data in one or more channels of the digital interface, and
wherein the secondary type of data is handled such that either the secondary type of data alone or in combination with the primary type of data is transmitted in the one or more channels of the digital interface.

28. The system as recited in claim 27, wherein the secondary type of data is embedded in the one or more channels of the digital interface such that both the primary type of data and the secondary type of data are transmitted together in the same one or more channels of the digital interface and wherein the digital interface is an audio digital interface and wherein the system is further configured by providing a balance between the secondary data type bandwidth and audio fidelity of the primary data type.

29. The system as recited in claim 27, further comprising a data return control path to verify that the secondary data type of the transmitted data has been received.

30. The system as recited in claim 28, wherein the secondary type of data is hidden in a portion of a bandwidth increase generated by sample rate conversion.

31. A receiver, comprising:
a processor configured to receive data transmitted from a sender via a digital interface and process the transmitted data,
wherein the transmitted data is data comprising a primary type of data and a secondary type of data,
wherein the digital interface is configured for transmitting the primary type of data as opposed to the secondary type of data in one or more channels of the digital interface, and
wherein the secondary type of data is handled such that either the secondary type of data alone or in combination with the primary type of data is transmitted in the one or more channels of the digital interface and wherein the secondary type of data is embedded in the one or more channels of the digital interface such that both the primary type of data and the secondary type of data are transmitted together in the same one or more channels of the digital interface.

32. The receiver as recited in claim 31, wherein the digital interface is an audio digital interface.

33. The receiver as recited in claim 32, wherein the processing of the transmitted data at the receiver further includes searching for and extracting the secondary type of data from the transmitted data.

34. The receiver as recited in claim 33, wherein the secondary type of data is hidden in a portion of a bandwidth generated by sample rate conversion.
